(19) United States
(12) Patent Application Publication
(10) Pub. No.: US 2020/0072315 A1
(43) Pub. Date: Mar. 5, 2020

(54) STOPPER AND VIBRATIONPROOFING UNIT

(71) Applicant: Toyo Tire Corporation, Itami-shi (JP)

(72) Inventors: Yoshiyuki Seno, Itami-shi (JP); Tatsuya Oniwa, Itami-shi (JP); Ryou Shibahara, Itami-shi (JP)

(73) Assignee: Toyo Tire Corporation, Itami-shi (JP)

(21) Appl. No.: 16/512,637

(22) Filed: Jul. 16, 2019

(30) Foreign Application Priority Data
Aug. 31, 2018 (JP) 2018-162432

(51) Int. Cl. F16F 15/08; F16F 1/387; F16F 1/38; F16F 1/373; B60K 5/12

(52) U.S. Cl. CPC F16F 15/08; F16F 1/387; B60K 5/12; F16F 1/373; F16F 1/3849

(57) ABSTRACT

A stopper is mounted on a vibrationproofing unit including a first bracket, a second bracket , an inside member being shaft shaped and in which the first bracket is fixed to the axial ends of the inside member, and a vibrationproofing base body including a rubber-like elastic body and coupling the outer circumferential face of the inside member and the inner circumferential face side of a tubular section of the second bracket. The stopper is plate shaped, includes a rubber-like elastic body, and includes a cushioning section disposed between the portions of the first bracket and the tubular section opposite in an axial direction of the tubular section. The cushioning section includes a thick wall section, a plurality of protrusion sections protruding from at least one face in a plate thickness direction of the thick wall section, and a thin wall section thinner than the thick wall section.

### TECHNICAL FIELD

The present invention relates to a stopper and a vibrationproofing unit. More specifically, the present invention relates to a stopper and a vibrationproofing unit capable of improving the durability of a bracket.

### BACKGROUND ART

Conventionally, a vibrationproofing unit that prevents vibration transmission while coupling a power unit side, such as an engine, and a vehicle body side has been known. Patent Literature 1 discloses such the vibrationproofing unit including a vibrationproofing device that couples an inside member being shaft shaped and an outside member being tubular shaped by a vibrationproofing base body including a rubber-like elastic body, a first bracket to which the axial ends of the inside member are fixed, a second bracket having a tubular section surrounding the outer circumferential face of the outside member and fixed to the outside member, and a stopper including a rubber-like elastic body. Further, in this vibrationproofing unit, the first bracket is fixed to the power unit, and a fixing face of the second bracket is fixed to the vehicle body side. To cushion the collision between the first bracket and the tubular section when the tubular section is moved in an axial direction relative to the first bracket by the input of a load to the first bracket and the second bracket, a cushioning section of the stopper is disposed between them.

### CITATION LIST

### [Patent Literature]

[Patent Literature 1] Japanese Unexamined Patent Application Publication No. 2013-170628

### SUMMARY OF INVENTION

### [Technical Problem]

However, in the above conventional art, at the time of the cushioning by the stopper, for example, when the inside member is displaced in the prying direction relative to the tubular section such that the first bracket is rotated about the fixing face side, the force moment from the first bracket toward the tubular section becomes larger in the portion closer to the symmetrical position of the fixing face with respect to the inside member, as viewed from the axial direction of the tubular section. Consequently, the locally large shock due to this large force moment is applied through the cushioning section to the first bracket and the tubular section, with the result that there is a problem that the durability of the first bracket and the second bracket is lowered.

The present invention has been made to solve the above problems and an object of the present invention is to provide a stopper and a vibrationproofing unit capable of improving the durability of a bracket.

### [Solution to Problem]

To achieve this object, a stopper of the present invention is mounted on a vibrationproofing unit including a first bracket fixed to one of a power unit side and a vehicle body side, a second bracket fixed to the other of the power unit side and the vehicle body side, an inside member being shaft shaped and in which the first bracket is fixed to the axial ends of the inside member, and a vibrationproofing base body including a rubber-like elastic body and coupling the outer circumferential face of the inside member and the inner circumferential face side of a tubular section of the second bracket. The stopper is plate shaped, includes a rubber-like elastic body, and includes a cushioning section disposed between the portions of the first bracket and the tubular section opposite in an axial direction of the tubular section. The cushioning section includes a thick wall section, a plurality of protrusion sections protruding from at least one face in a plate thickness direction of the thick wall section, and a thin wall section thinner than the thick wall section.

Also, a vibrationproofing unit of the present invention includes a first bracket fixed to one of a power unit side and a vehicle body side, a second bracket having a tubular section opposite a portion of the first bracket in an axial direction and a fixing face fixed in contact with the other of the power unit side and the vehicle body side, an inside member being shaft shaped, disposed on the inner circumferential side of the tubular section, and in which the first bracket is fixed to the axial ends of the inside member, a vibrationproofing base body including a rubber-like elastic body and coupling the outer circumferential face of the inside member and the inner circumferential face side of the tubular section, and a stopper being plate shaped and including a rubber-like elastic body. The stopper includes a cushioning section disposed between the portions of the first bracket and the tubular section opposite in the axial direction. The cushioning section includes a thick wall section, and a thin wall section thinner than the thick wall section. At least a portion of the thin wall section is provided in the portion in which the first bracket and the tubular section are overlapped, as viewed from the axial direction and closest to a symmetrical position of the fixing face with respect to the inside member.

### [Advantageous Effects of Invention]

According to the stopper of a first aspect, the thin wall section thinner than the thick wall section from which the plurality of protrusion sections protrude is provided in the cushioning section. Therefore, even when the load to sandwich the cushioning section between the first bracket and the tubular section of the second bracket is inputted, the thin wall section is difficult to be sandwiched between the first bracket and the tubular section, so that the shock can be difficult to be applied to the first bracket and the tubular section on both sides of the thin wall section. The thin wall section is provided in the portion in which the shock applied to between the first bracket and the tubular section is likely to be large, and can thus be difficult to cause the locally large shock. As a result, the durability of the first bracket and the second bracket can be improved.

According to the stopper of a second aspect, in addition to the effect exhibited by the stopper of the first aspect, the following effect is exhibited. A portion of the thick wall section is provided between the edge of the cushioning section and the thin wall section. Thus, during the molding of the stopper by using a mold, the rubber-like elastic body can be easily filled into the edge of the cushioning section and the portion of the cushioning section corresponding to the thin wall section, so that the moldability of the stopper can be improved.

According to the stopper of a third aspect, in addition to the effect exhibited by the stopper of the second aspect, the following effect is exhibited. A portion of the thick wall section is continuously provided on the entire periphery of the thin wall section. Thus, during the molding of the stopper by using a mold, the rubber-like elastic body can be filled into the portion of the cushioning section corresponding to the thin wall section more easily, so that the moldability of the stopper can be further improved.

According to the vibrationproofing unit of a fourth aspect, when the load to sandwich the cushioning section between the first bracket and the tubular section is inputted, the inside member is sometimes displaced in the prying direction relative to the tubular section such that the first bracket is rotated about the fixing face side. In this case, the largest force moment from the first bracket toward the tubular section is applied to the portion in which the first bracket and the tubular section are overlapped, as viewed from the axial direction of the tubular section and closest to the symmetrical position of the fixing face with respect to the inside member. In the portion to which this large force moment is applied, at least a portion of the thin wall section thinner than the thick wall section is provided, so that the shock with the locally large force moment can be difficult to be applied through the thin wall section to the first bracket and the tubular section. As a result, the durability of the first bracket and the second bracket can be improved.

According to the vibrationproofing unit of a fifth aspect, in addition to the effect exhibited by the vibrationproofing unit of the fourth aspect, the following effect is exhibited. The first bracket and the tubular section are overlapped, as viewed from the axial direction of the tubular section, in the symmetrical position of the fixing face with respect to the inside member. In this overlapping portion, the force moment from the first bracket toward the tubular section is the largest at the time of the relative displacement such that the first bracket is rotated about the fixing face side. However, since the thin wall section is provided in the overlapping portion, the shock with the largest force moment can be difficult to be applied through the thin wall section to the first bracket and the tubular section. As a result, the durability of the first bracket and the second bracket can be further improved.

According to the vibrationproofing unit of a sixth aspect, in addition to the effect exhibited by the vibrationproofing unit of the fourth aspect, the following effect is exhibited. The thick wall section is provided over the portion of the cushioning section away from the symmetrical position with respect to the thin wall section. In the portion of the cushioning section away from the position where the force moment locally becomes large (the portion in which the force moment is relatively small), the shock between the first bracket and the tubular section can be sufficiently cushioned by the thick wall section that is relatively thick. Thus, the thin wall section is difficult to be sandwiched between the first bracket and the tubular section, so that the shock can be more difficult to be applied through the thin wall section to the first bracket and the tubular section. Therefore, the durability of the first bracket and the second bracket can be further improved.

According to the vibrationproofing unit of a seventh aspect, in addition to the effect exhibited by the vibrationproofing unit of the fourth aspect, the following effect is exhibited. The first bracket is fixed to the power unit side, and the fixing face of the second bracket is fixed to the vehicle body side. A first face of the cushioning section faces the first bracket, and a second face of the cushioning section that is the back side of the first face faces the tubular section. The thin wall section is recessed with respect to the thick wall section on the first face, and is formed such that the thick wall section and the thin wall section are coplanarly joined on the second face. Thus, when the cushioning section is sandwiched between the first bracket and the tubular section, the thin wall section can be difficult to come into contact with the first bracket, and the vibration of the power unit can be difficult to be transmitted through the first bracket to the thin wall section. As a result, the durability of the thin wall section can be secured.

According to the vibrationproofing unit of an eighth aspect, in addition to the effect exhibited by the vibrationproofing unit of the fourth aspect, the following effect is exhibited. The cushioning section includes a plurality of protrusion sections protruding from at least one face in a plate thickness direction of the thick wall section. When the cushioning section is sandwiched between the first bracket and the tubular section by the input of the load, first, the protrusion sections are compressed and deformed, and after the thick wall section in the portion thereof in which each of the plurality of protrusion sections is not provided is compressed and deformed, the thin wall section is sandwiched between them when the input load is large. Therefore, the shock can be more difficult to be applied through the thin wall section to the first bracket and the tubular section, so that the durability of the first bracket and the second bracket can be further improved.

### BRIEF DESCRIPTION OF DRAWINGS

FIG. 1 is a perspective view of a vibrationproofing unit according to an embodiment;

FIG. 2 is a right side view of the vibrationproofing unit;

FIG. 3 is a left side view of the vibrationproofing unit;

FIG. 4A is a cross-sectional view of the vibrationproofing unit taken along line IVa-IVa in FIGS. 2 and 3; and

FIG. 4B is a cross-sectional view of the vibrationproofing unit when a load is inputted.

### MODE FOR CARRYING OUT INVENTION

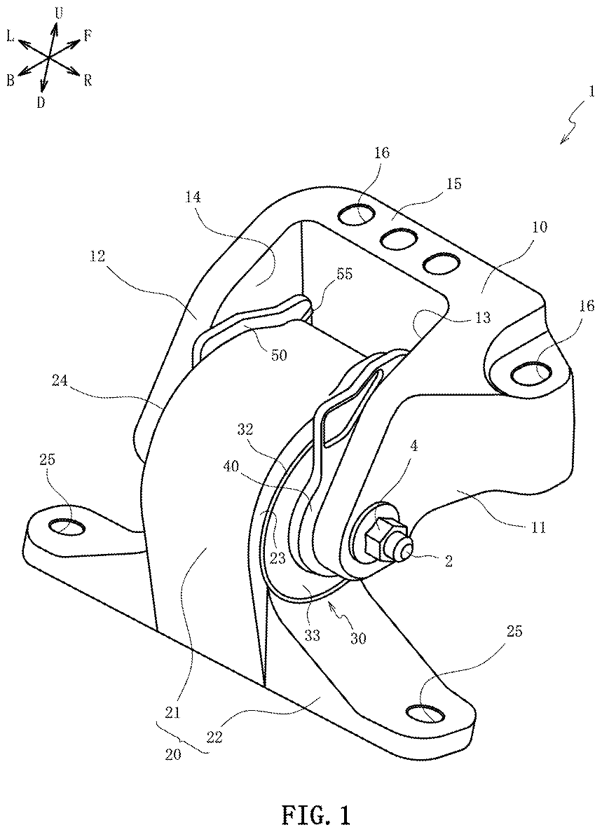

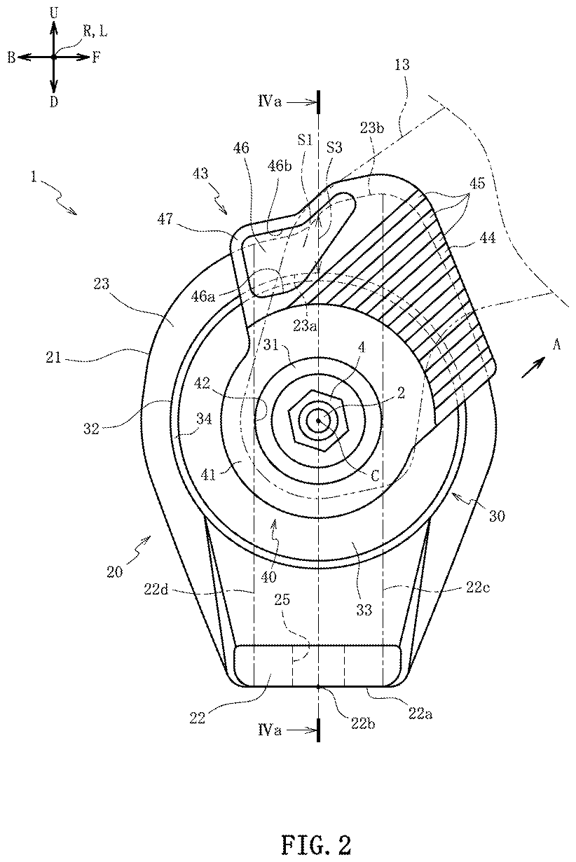

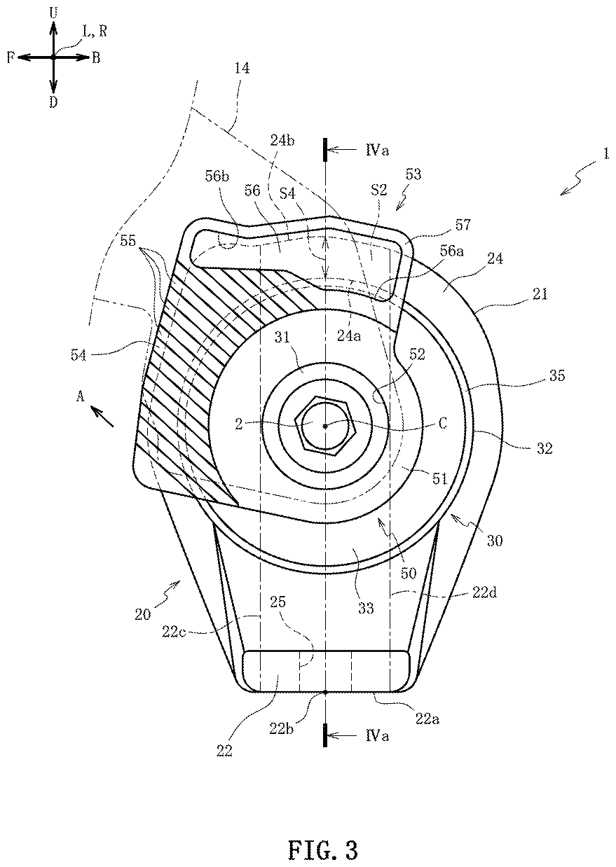

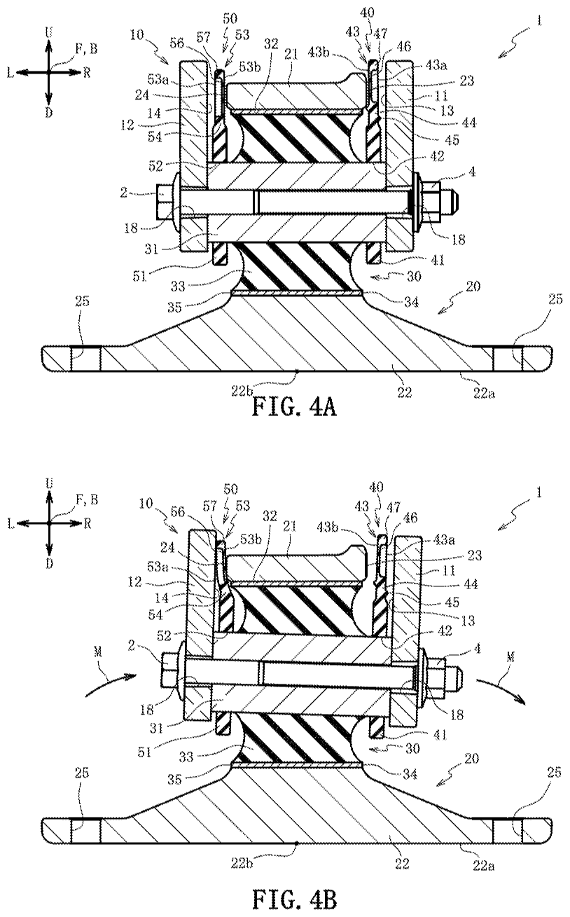

A preferred embodiment will be described below with reference to the accompanying drawings. First, referring to FIGS. 1 and 4A, a vibrationproofing unit 1 according to an embodiment will be described. FIG. 1 is a perspective view of the vibrationproofing unit 1 according to the embodiment. FIG. 4A is a cross-sectional view of the vibrationproofing unit 1 taken along line IVa-IVa in FIGS. 2 and 3. It should be noted that FIGS. 4A and 4B illustrate only the end face of the cross-sectional portion of a first bracket 10. An arrow U, an arrow D, an arrow L, an arrow R, an arrow F, and an arrow B of each drawing denote the up direction, the down direction, the left direction, the right direction, the front direction, and the back direction of the vibrationproofing unit 1, respectively. It should be noted that the up-down direction, the left-right direction, and the front-back direction of the vibrationproofing unit 1 do not necessarily coincide with the up-down direction, the left-right direction, and the front-back direction of the vehicle on which the vibrationproofing unit 1 is mounted.

As illustrated in FIG. 1, the vibrationproofing unit 1 is an engine mount that prevents vibration transmission while coupling a power unit (not illustrated), such as an engine, and a vehicle body (not illustrated). The vibrationproofing unit 1 includes the first bracket 10 fixed to the power unit side, a second bracket 20 fixed to the vehicle body side, a vibrationproofing device 30 coupling the first bracket 10 and the second bracket 20, and stoppers 40 and 50 disposed between the first bracket 10 and the second bracket 20.

The first bracket 10 is a member that is made of a substantially U-shaped aluminum alloy and sandwiches the vibrationproofing device 30. The first bracket 10 includes a pair of right and left side sections 11 and 12 in which inner wall faces 13 and 14 are opposite each other, and a coupling section 15 that couples the front sides of the pair of side sections 11 and 12. In the first bracket 10, a plurality of bolt holes 16 are formed to extend therethrough. The first bracket 10 is fastened and fixed to the power unit side by passing bolts (not illustrated) through the bolt holes 16.

The shape of the first bracket 10 and the positions of the bolt holes 16 are set according to the shape, the gravity center position, and the like of the power unit. In this embodiment, three bolt holes 16 are provided in the coupling section 15, and one bolt hole 16 is provided in the portion of the first bracket 10 extending from the side section 11 to the right side (the opposite side of the coupling section 15). Also, the shape of the inner wall face 13 of the side section 11 and the shape of the inner wall face 14 of the side section 12 are different.

The second bracket 20 is a member made of an aluminum alloy. The second bracket 20 includes a tubular section 21 that is substantially cylindrically shaped, and a fixing section 22 disposed in a portion in a circumferential direction of the tubular section 21. The tubular section 21 is disposed between the inner wall faces 13 and 14. In the tubular section 21, an end face 23 in an axial direction on the inner wall face 13 side and an end face 24 in the axial direction on the inner wall face 14 side are different in shape. In particular, the shape of the end face 23 in the portion of the tubular section 21 opposite the inner wall face 13 in the axial direction (the upper side) and the shape of the end face 24 in the portion of the tubular section 21 opposite the inner wall face 14 in the axial direction (the upper side) are different.

The fixing section 22 is disposed in the lower portion of the tubular section 21, and is provided to extend from the lower end of the tubular section 21 in each of the left and right directions. At both ends that are extended, bolt holes 25 are formed to extend through the fixing section 22 in the up-down direction. The fixing section 22 is fastened and fixed to the vehicle body side by passing bolts through the bolt holes 25. At this time, the face of the fixing section 22 that comes in contact with the vehicle body side is a fixing face 22a.

As illustrated in FIG. 1 and FIG. 4A, the vibrationproofing device 30 is a cylindrical bush. The vibrationproofing device 30 includes an inside member 31 that is cylindrically shaped, an outside member 32 that is cylindrically shaped and disposed on the outer circumferential side of the inside member 31 to be spaced from the inside member 31 and to be coaxial with the inside member 31, and a vibrationproofing base body 33 that includes a rubber-like elastic body and couples the outer circumferential face of the inside member 31 and the inner circumferential face of the outside member 32.

The inside member 31 is a member that includes a steel material and a rigid material, such as an aluminum alloy. In a state where the inside member 31 is sandwiched between the side sections 11 and 12 of the first bracket 10 in the axial direction, bolts 2 are inserted into the inner circumferential side of the inside member 31 and a through hole 18 of the first bracket 10, and nuts 4 are tightened to the bolts 2, so that the axial ends of the inside member 31 are respectively fixed to the side sections 11 and 12. It should be noted that the present invention is not limited to the case where the inside member 31 is fastened and fixed to the first bracket 10 by using the bolts 2 and the nuts 4, and the inside member 31 may be mounted on the first bracket 10 by using a shaft-like member, such as a rivet.

The outside member 32 is a member that is cylindrically shaped and includes a steel material and a rigid material, such as an aluminum alloy. The dimension in the axial direction (the left-right direction) of the outside member 32 is smaller than the dimension in the axial direction of the inside member 31. The outside member 32 is pressed into the tubular section 21 of the second bracket 20, its outer circumferential face being fixed to the inner circumferential face of the tubular section 21. The dimension in the axial direction of the outside member 32 is smaller than the dimension in the axial direction of the tubular section 21. Therefore, in a state where the outside member 32 is fixed to the tubular section 21, an end face 34 in the axial direction of the outside member 32 is located inside in the axial direction with respect to the end face 23 of the tubular section 21, and in a state where the outside member 32 is fixed to the tubular section 21, an end face 35 in the axial direction of the outside member 32 is located inside in the axial direction with respect to the end face 24 of the tabular section 21.

Next, the stopper 40 will be described with reference to FIG. 2, and the stopper 50 will be described with reference to FIG. 3. FIG. 2 is a right side view of the vibrationproofing unit 1. FIG. 3 is a left side view of the vibrationproofing unit 1. It should be noted that in FIG. 2, while the illustration of the first bracket 10 is omitted, the outline of the inner wall face 13 of the first bracket 10 is indicated by the alternate long and two short dashes line. In FIG. 3, while the illustration of the first bracket 10 is omitted, the outline of the inner wall face 14 of the first bracket 10 is indicated by the alternate long and two short dashes line.

As illustrated in FIG. 2, the stopper 40 is a plate-shaped member including a rubber-like elastic body, and as illustrated in FIG. 3, the stopper 50 is a plate-shaped member including a rubber-like elastic body. The stopper 40 is disposed between the inner wall face 13 of the first bracket 10 and the end face 23 of the second bracket 20. The stopper 50 is disposed between the inner wall face 14 of the first bracket 10 and the end face 24 of the second bracket 20.

The stopper 40 includes a mounting section 41 that is annular shaped and in which a mounting hole 42 extending through the mounting section 41 in a plate thickness direction (the left-right direction) is provided at the center of the mounting section 41, and a cushioning section 43 joined to the mounting section 41. The stopper 50 includes a mounting section 51 that is annular shaped and in which a mounting hole 52 extending through the mounting section 51 in the plate thickness direction (the left-right direction) is provided at the center of the mounting section 51, and a cushioning section 53 joined to the mounting section 51. By fitting the inside member 31 into the mounting hole 42 of the mounting section 41 and the mounting hole 52 of the mounting section 51, the stoppers 40 and 50 are mounted on the inside member 31.

The cushioning section 43 is a plate-shaped portion that is provided to be joined to a portion of the circumferential edge of the annular mounting section 41 and to extend in an extension direction A that is a radial direction. The cushioning section 53 is a plate-shaped portion that is provided to be joined to a portion of the circumferential edge of the annular mounting section 51 and to extend in the extension direction A that is the radial direction. The cushioning section 43 is disposed between the portions of the inner wall face 13 and the end face 23 opposite in the axial direction. Of both faces in the plate thickness direction of the cushioning section 43, a first face 43a (see FIGS. 4A and 4B) faces the inner wall face 13, and a second face 43b (see FIGS. 4A and 4B) faces the end face 23.

The cushioning section 53 is disposed between the portions of the inner wall face 14 and the end face 24 opposite in the axial direction. Of both faces in the plate thickness direction of the cushioning section 53, a first face 53a (see FIGS. 4A and 4B) faces the inner wall face 14, and a second face 53b (see FIGS. 4A and 4B) faces the end face 24.

The cushioning section 43 includes a thick wall section 44 that is plate shaped, a plurality of protrusion sections 45 respectively protruding from the first face 43a and the second face 43b of the thick wall section 44, and a thin wall section 46 that is film-like and is thinner than the thick wall section 44. The cushioning section 53 includes a thick wall section 54 that is plate shaped, a plurality of protrusion sections 55 respectively protruding from the first face 53a and the second face 53b of the thick wall section 54, and a thin wall section 56 that is film-like and is thinner than the thick wall section 54.

The protrusion sections 45 and 55 are the portions linearly disposed toward the extension direction A, and are continuous over the entire length thereof. The protrusion sections 45 protrude in a substantially triangle shape from the first face 43a and the second face 43b of the thick wall section 44. The protrusion sections 55 protrude in a substantially triangle shape from the first face 53a and the second face 53b of the thick wall section 54. The protrusion sections 45 are alternately disposed on the first face 43a and the second face 43b. The protrusion sections 55 are alternately disposed on the first face 53a and the second face 53b.

The thin wall sections 46 and 56 are each a film-like portion having a thickness of approximately 1 mm. The thin wall section 46 is recessed with respect to the thick wall section 44 on the first face 43a, and is formed to be coplanarly joined to the thick wall section 44 on the second face 43b. The thin wall section 56 is recessed with respect to the thick wall section 54 on the first face 53a, and is formed to be coplanarly joined to the thick wall section 54 on the second face 53b.

Between the edge of the cushioning section 43 and the thin wall section 46, a rib 47 that is a portion of the thick wall section 44 is provided. Between the edge of the cushioning section 53 and the thin wall section 56, a rib 57 that is a portion of the thick wall section 54 is provided. A portion of the thick wall section 44 including the rib 47 is continuously provided on the entire periphery of the thin wall section 46. A portion of the thick wall section 54 including the rib 57 is continuously provided on the entire periphery of the thin wall section 56. Thus, when the stopper 40 is formed by using a mold (not illustrated), the rubber-like elastic body can be easily filled into the edge of the cushioning section 43 (the rib 47) and the portion of the cushioning section 43 corresponding to the thin wall section 46 having a thickness of approximately 1 mm, and when the stopper 50 is formed by using a mold (not illustrated), the rubber-like elastic body can be easily filled into the edge of the cushioning section 53 (the rib 57) and the portion of the cushioning section 53 corresponding to the thin wall section 56 having a thickness of approximately 1 mm. Also, the tilting of the thin wall section 46 having a thickness of approximately 1 mm in the down direction can be prevented by the rib 47, and the tilting of the thin wall section 56 having a thickness of approximately 1 mm in the down direction can be prevented by the rib 57.

The thin wall section 46 is formed along the outline shape of the end face 23 of the second bracket 20 that the thin wall section 46 faces in the plate thickness direction (the axial direction of the tubular section 21). The thin wall section 46 includes an inner edge 46a located inside in the radial direction with respect to the end face 23, and an outer edge 46b located outside in the radial direction with respect to the end face 23. The length of the outer edge 46b is approximately twice the length of the inner edge 46a.

The thin wall section 56 is formed along the outline shape of the end face 24 of the second bracket 20 that the thin wall section 56 faces in the plate thickness direction. The thin wall section 56 includes an inner edge 56a located inside in the radial direction with respect to the end face 24, and an outer edge 56b located outside in the radial direction with respect to the end face 24. The length of the outer edge 56b is approximately three times the length of the inner edge 56a.

At least a portion of the thin wall section 46 is provided in the portion in which the inner wall face 13 and the end face 23 are overlapped (opposite), as viewed in the plate thickness direction (as viewed from the axial direction of the tubular section 21) and closest to a symmetrical position S1 of the fixing face 22a with respect to the inside member 31. Also, at least a portion of the thin wall section 56 is provided in the portion in which the inner wall face 14 and the end face 24 are overlapped, as viewed in the plate thickness direction and closest to a symmetrical position S2 of the fixing face 22a with respect to the inside member 31.

It should be noted that the symmetrical position S1 herein indicates the range surrounded by tracks 22c and 22d at both end edges of the fixing face 22a when as viewed in the plate thickness direction, the fixing face 22a is moved in parallel with the straight line passing through a fastening point 22b that is the center of the fixing face 22a and an axis C of the inside member 31 and an inner circumferential edge 23a and an outer circumferential edge 23b of the end face 23, and that the symmetrical position S2 herein indicates the range surrounded by the tracks 22c and 22d at both end edges of the fixing face 22a when as viewed in the plate thickness direction, the fixing face 22a is moved in parallel with the straight line passing through the fastening point 22b that is the center of the fixing face 22a and the axis C of the inside member 31 and an inner circumferential edge 24a and an outer circumferential edge 24b of the end face 24.

Further, at least a portion of the thin wall section 46 is provided in the portion in which the inner wall face 13 and the end face 23 are overlapped, as viewed in the plate thickness direction and closest to a symmetrical line segment S3 of the fastening point 22b with respect to the axis C. Also, at least a portion of the thin wall section 56 is provided in the portion in which the inner wall face 14 and the end face 24 are overlapped, as viewed in the plate thickness direction and closest to a symmetrical line segment S4 of the fastening point 22b with respect to the axis C. The symmetrical line segment S3 is the line segment between the inner circumferential edge 23a and the outer circumferential edge 23b of the end face 23 of the straight line passing through the axis C and the fastening point 22b, as viewed in the plate thickness direction. The symmetrical line segment S4 is the line segment between the inner circumferential edge 24a and the outer circumferential edge 24b of the end face 24 of the straight line passing through the axis C and the fastening point 22b, as viewed in the plate thickness direction.

It should be noted that the portion closest to the symmetrical position S1 and the symmetrical line segment S3 includes the overlapping portion in which the inner wall face 13 and the end face 23 are overlapped, as viewed in the plate thickness direction, in the symmetrical position S1 and the symmetrical line segment S3, and that the portion closest to the symmetrical position S2 and the symmetrical line segment S4 includes the overlapping portion in which the inner wall face 14 and the end face 24 are overlapped, as viewed in the plate thickness direction, in the symmetrical position S2 and the symmetrical line segment S4. In this embodiment, the inner wall face 13 and the end face 23 are overlapped, as viewed in the plate thickness direction, in the symmetrical position S1 and the symmetrical line segment S3, and the inner wall face 14 and the end face 24 are overlapped, as viewed in the plate thickness direction, in the symmetrical position S2 and the symmetrical line segment S4. And, at least a portion of the thin wall section 46 is overlapped with the symmetrical position S1 and the symmetrical line segment S3, and at least a portion of the thin wall section 56 is overlapped with the symmetrical position S2 and the symmetrical line segment S4.

The thick wall section 44 is provided over the portion of the cushioning section 43 away from the symmetrical line segment S3 (the symmetrical position S1) with respect, to the thin wall section 46. The thick wall section 54 is provided over the portion of the cushioning section 53 away from the symmetrical line segment S4 (the symmetrical position S2) with respect to the thin wall section 56. It should be noted that a portion of the thick wall section 44 may be included in the symmetrical line segment S3 and the symmetrical position S1, and that a portion of the thick wall section 54 may be included in the symmetrical line segment S4 and the symmetrical position S2.

Here, the shapes of the inner wall faces 13 and 14 and the shapes of the end faces 23 and 24 are set according to the shape and the gravity center position of the power unit fixed to the first bracket 10, the way in which the first bracket 10 is fixed to the power unit side, and the like. In detail, when the first bracket 10 is moved in the axial direction of the tubular section 21 relative to the second bracket 20 fixed to the vehicle body, the shape of the inner wall face 13 and the shape of the end face 23 are set according to the magnitude of the shock that attempts to be applied from the inner wall face 13 to the end face 23 and the way in which the shock is applied, and when the first bracket 10 is moved in the axial direction of the tubular section 21 relative to the second bracket 20 fixed to the vehicle body, the shape of the inner wall face 14 and the shape of the end face 24 are set according to the magnitude of the shock that attempts to be applied from the inner wall face 14 to the end face 24 and the way in which the shock is applied.

Since the bolt hole 16 is present in the portion of the first bracket 10 that extends from the side section 11 having the inner wall face 13 to the right side, the way in which the load is applied from the inner wall face 13 to the end face 23 and the way in which the load is applied from the inner wall face 14 to the end face 24 are different. Therefore, the inner wall face 13 and the inner wall face 14 are different in shape, and the end face 23 and the end face 24 are different in shape.

In detail, as compared with the portion in which the inner wall face 13 and the end face 23 are overlapped, as viewed in the plate thickness direction, a portion of the inner wall face 14 is formed to extend to the fixing section 22 side so that the inner wall face 14 and the end face 24 are overlapped to the side close to the fixing section 22. Also, the end face 23 extends with respect to the end face 24 in the A direction such that the center side in the circumferential direction of the portion in which the end face 23 and the inner wall face 13 are overlapped, as viewed in the plate thickness direction, extends in the A direction.

The shape of the thick wall section 44 on which the protrusion sections 45 are provided is set according to the shapes of the inner wall face 13 and the end face 23 and the way in which the load is applied from the inner wall face 13 to the end face 23. Also, the shape of the thick wall section 54 on which the protrusion sections 55 are provided is set according to the shapes of the inner wall face 14 and the end face 24 and the way in which the load is applied from the inner wall face 14 to the end face 24. In particular, the area of each of the protrusion sections 45 in the portion sandwiched between the inner wall face 13 and the end face 23, as viewed in the plate thickness direction and the area of each of the protrusion sections 55 in the portion sandwiched between the inner wall face 14 and the end face 24, as viewed in the plate thickness direction are set so as to be substantially the same.

The thin wall section 46 is provided in the portion of the cushioning section 43 in which the thick wall section 44 is not disposed between the inner wall face 13 and the end face 23, as viewed in the plate thickness direction while satisfying the conditions to provide such the thick wall section 44 and the protrusion sections 45. The thin wall section 56 is provided in the portion of the cushioning section 53 in which the thick wall section 54 is not disposed between the inner wall face 14 and the end face 24, as viewed in the plate thickness direction while satisfying the conditions to provide such the thick wall section 54 and the protrusion sections 55. Therefore, the thin wall section 46 and the thin wall section 56 are different in shape.

Next, in addition to FIGS. 2 and 3, referring to FIGS. 4A and 4B, the behavior when the load is inputted to the vibrationprooofing unit 1 will be described. FIG. 4A is a cross-sectional view of the vibrationprooofing unit 1 when the load is not inputted. FIG. 4B is a cross-sectional view of the vibrationprooofing unit 1 when the load is inputted.

The case where the load such that the first bracket 10 is moved in the left-right direction (the axial direction of the tubular section 21) relative to the second bracket 20 is inputted from the state where the load is not inputted, as illustrated in FIG. 4A will be described. Hereinafter, such the load is called an input load for description.

As illustrated in FIG. 4B, when the input load is large, the cushioning section 43 of the stopper 40 comes into contact with the end face 23 so that the cushioning section 43 and the end face 23 mutually receive the load, and when the input load is large, the cushioning section 53 of the stopper 50 comes into contact with the end face 24 so that the cushioning section 53 and the end face 24 mutually receive the load. When the input load is larger, the inner wall face 13 comes into contact with the cushioning section 43, the cushioning section 43 is sandwiched between the inner wall face 13 and the end face 23, and the inner wall face 13 and the end face 23 mutually receive the load through the cushioning section 43. When the input load is larger, the inner wall face 14 comes into contact with the cushioning section 53, the cushioning section 53 is sandwiched between the inner wall face 14 and the end face 24, and the inner wall face 14 and the end face 24 mutually receive the load through the cushioning section 53.

The fixing face 22a fixed to the vehicle body side is located in a portion in the circumferential direction of the tubular section 21, and the load is inputted from the first bracket 10 to the inside member 31 located on the inner circumferential side of the tubular section 21. Therefore, by the input load in the right direction, the inside member 31 is displaced in the prying direction relative to the tubular section 21 in a moving direction M such that the first bracket 10 is rotated about the fastening point 22b (the fixing face 22a side). Likewise, by the input load in the left direction, the inside member 31 is displaced in the prying direction relative to the tubular section 21 such that the first bracket 10 is rotated about the fastening point 22b. It should be noted that in the cross section vertical to the fixing face 22a like FIGS. 4A and 4B, the intersection point of the vertical line vertical to the fixing face 22a through the center point in the axial direction of the tubular section 21 and the fixing face 22a is the fastening point 22b.

In this way, at the time of the relative displacement in the prying direction, as illustrated in FIG. 2, the force moment from the inner wall face 13 toward the end face 23 becomes larger in the portion in which the inner wall face 13 of the first bracket 10 and the end face 23 of the tubular section 21 are overlapped, as viewed from the axial direction of the tubular section 21 and closer to the symmetrical line segment S3 of the fastening point 22b with respect to the axis C of the inside member 31. At the time of the relative displacement in the prying direction, as illustrated in FIG. 3, the force moment from the inner wall face 14 toward the end face 24 becomes larger in the portion in which the inner wall face 14 of the first bracket 10 and the end face 24 of the tubular section 21 are overlapped, as viewed from the axial direction of the tubular section 21 and closer to the symmetrical line segment S4 of the fastening point 22b with respect to the axis C of the inside member 31. Here, when the cushioning section 43 is sandwiched between the inner wall face 13 and the end face 23 to apply the locally large shock caused by the locally large force moment to the cushioning section 43, so that the durability of the cushioning section 43 is likely to be lowered. When the cushioning section 53 is sandwiched between the inner wall face 14 and the end face 24 to apply the locally large shock caused by the locally large force moment to the cushioning section 53, so that the durability of the cushioning section 53 is likely to be lowered.

Also, when the locally large shock is applied through the cushioning sections 43 and 53 to the first bracket 10 and the second bracket 20, the durability of the first bracket 10 and the second bracket 20 is likely to be lowered. In particular, since the first bracket 10 and the second bracket 20 are made of relatively soft aluminum alloys, the durability of the first bracket 10 and the second bracket 20 is likely to be lowered by the locally large shock. Further, when the shock is applied from the first bracket 10 side to the tubular section 21, the stress such that the tubular section 21 is tilted in the axial direction with respect to the fixing face 22a is caused, so that the durability of the second bracket 20 is particularly likely to be lowered.

In the mutual comparison, the thick wall section 44 that is thicker than the thin wall section 46 and the thin wall section 46 that is thinner than the thick wall section 44 are provided in the cushioning section 43, and in the mutual comparison, the thick wall section 54 that is thicker than the thin wall section 56 and the thin wall section 56 that is thinner than the thick wall section 54 are provided in the cushioning section 53. Therefore, when the cushioning section 43 is sandwiched between the inner wall face 13 and the end face 23 by the input load, the thin wall section 46 can be difficult to be sandwiched therebetween, and when the cushioning section 53 is sandwiched between the inner wall face 14 and the end face 24 by the input load, the thin wall section 56 can be difficult to be sandwiched therebetween. Therefore, the shock can be difficult to be applied to the first bracket 10 and the tubular section 21 on both sides in the left-right direction of the thin wall section 46 and on both sides in the left-right direction of the thin wall section 56.

Further, the protrusion sections 45 respectively protrude from the first face 43a and the second face 43b of the thick wall section 44, and the protrusion sections 55 respectively protrude from the first face 53a and the second face 53b of the thick wall section 54. Therefore, when the cushioning section 43 is sandwiched between the inner wall face 13 and the end face 23, first, the protrusion sections 45 are compressed and deformed, and after the thick wall section 44 in the portion thereof in which each of the plurality of protrusion sections 45 is not provided is compressed and deformed, the thin wall section 46 is sandwiched between the inner wall face 13 and the end face 23 when the input load is large. When the cushioning section 53 is sandwiched between the inner wall face 14 and the end face 24, first, the protrusion sections 55 are compressed and deformed, and after the thick wall section 54 in the portion thereof in which each of the plurality of protrusion sections 55 is not provided is compressed and deformed, the thin wall section 56 is sandwiched between the inner wall face 14 and the end face 24 when the input load is large. Therefore, the shock can be more difficult to be applied through the thin wall sections 46 and 56 to the first bracket 10 and the tubular section 21.

At least a portion of such the thin wall section 46 is provided in the portion in which the inner wall face 13 and the end face 23 are overlapped, as viewed from the axial direction of the tubular section 21 and closest to the symmetrical position S1 of the fixing face 22a with respect to the inside member 31 (the portion in which the force moment is likely to be large). At least a portion of such the thin wall section 56 is provided in the portion in which the inner wall face 14 and the end face 24 are overlapped, as viewed from the axial direction of the tubular section 21 and closest to the symmetrical position S2 of the fixing face 22a with respect to the inside member 31 (the portion in which the force moment is likely to be large). As a result, the shock with the locally large force moment can be difficult to be applied through the thin wall sections 46 and 56 to the first bracket 10 and the tubular section 21. As a result, the durability of the first bracket 10, the second bracket 20, and the cushioning sections 43 and 53 can be improved.

In particular, at least a portion of the thin wall section 46 is provided in the portion in which the force moment becomes larger and closest to the symmetrical line segment S3 of the fastening point 22b with respect to the axis C, and at least a portion of the thin wall section 56 is provided in the portion in which the force moment becomes larger and closest to the symmetrical line segment S4 of the fastening point 22b with respect to the axis C. As a result, the shock with the larger force moment can be difficult to be applied through the thin wall sections 46 and 56 to the first bracket 10 and the tubular section 21.

Further, the position where the inner wall face 13 and the end face 23 are overlapped, as viewed from the axial direction of the tubular section 21, includes the symmetrical line segment S3 in which the force moment is the largest, and the position where the inner wall face 14 and the end face 24 are overlapped, as viewed from the axial direction of the tubular section 21, includes the symmetrical line segment S4 in which the force moment is the largest. Since at least a portion of the thin wall section 46 is overlapped with the symmetrical position S1 and the symmetrical line segment S3, the shock with the largest force moment can be difficult to be applied through the thin wall section 46 to the first bracket 10 and the tubular section 21. Since at least a portion of the thin wall section 56 is overlapped with the symmetrical position S2 and the symmetrical line segment S4, the shock with the largest force moment can be difficult to be applied through the thin wall section 56 to the first bracket 10 and the tubular section 21. As a result, the durability of the first bracket 10, the second bracket 20, and the cushioning sections 43 and 53 can be further improved.

The force moment from the inner wall face 13 toward the end face 23 becomes larger in the portion in which the thin wall section 46 is sandwiched between the inner wall face 13 and the end face 23 and closer to outside in the radial direction of the tubular section 21. The force moment from the inner wall face 14 toward the end face 24 becomes larger in the portion in which the thin wall section 56 is sandwiched between the inner wall face 14 and the end face 24 and closer to outside in the radial direction of the tubular section 21. Since the length of the outer edge 46b of the thin wall section 46 is larger than the length of the inner edge 46a, the shock can be difficult to be applied through the thin wall section 46 to the inner wall face 13 and the end face 23 on the outer edge 46b side with respect to the inner edge 46a (outside in the radial direction). Since the length of the outer edge 56b of the thin wall section 56 is larger than the length of the inner edge 56a, the shock can be difficult to be applied through the thin wall section 56 to the inner wall face 14 and the end face 24 on the outer edge 56b side with respect to the inner edge 56a (outside in the radial direction). Thus, the shock in the portion in which the force moment becomes large can be difficult to be applied, so that the durability of the first bracket 10, the second bracket 20, and the cushioning sections 43 and 53 can be further improved.

It should be noted that as the ratio of the length of the outer edge 46b to the length of the inner edge 46a is larger, the shock can be more difficult to be applied on the outer edge 46b side with respect to the inner edge 46a, and that as the ratio of the length of the outer edge 56b to the length of the inner edge 56a is larger, the shock can be more difficult to be applied on the outer edge 56b side with respect to the inner edge 56a. While the outer edge 46b of the thin wall section 46 is approximately twice the inner edge 46a, the outer edge 56b of the thin wall section 56 is approximately three times the inner edge 56a. Thus, as compared with the stopper 40 having the thin wall section 46, the stopper 50 having the thin wall section 56 can be difficult to apply the shock caused by the large force moment.

The thin wall section 46 is formed along the outline shape of the end face 23 of the second bracket 20 that, the thin wall section 46 faces in the plate thickness direction. The thin wall section 56 is formed along the outline shape of the end face 24 of the second bracket 20 that the thin wall section 56 faces in the plate thickness direction. Therefore, the thin wall section 46 can be more difficult to be sandwiched between the inner wall face 13 and the end face 23, and the thin wall section 56 can be more difficult to be sandwiched between the inner wall face 14 and the end face 24.

Also, since the thin wall section 46 is formed along the outline shape of the end face 23 that the thin wall section 46 faces in the plate thickness direction, when the thin wall section 46 comes into contact with the end face 23, the load can be inputted from the end face 23 to substantially the entire thin wall section 46. Since the thin wall section 56 is formed along the outline shape of the end face 24 that the thin wall section 56 faces in the plate thickness direction, when the thin wall section 56 comes into contact with the end face 24, the load can be inputted from the end face 24 to substantially the entire thin wall section 56. On the other hand, since only a portion of the thin wall section 46 in the circumferential direction of the inside member 31 is overlapped with the inner wall face 13, as viewed in the plate thickness direction, when the thin wall section 46 comes into contact with the inner wall face 13, the load is inputted from the inner wall face 13 to a portion of the thin wall section 46. Since only a portion of the thin wall section 56 in the circumferential direction of the inside member 31 is overlapped with the inner wall face 14, as viewed in the plate thickness direction, when the thin wall section 56 comes into contact with the inner wall face 14, the load is inputted from the inner wall face 14 to a portion of the thin wall section 56. Thus, there is a fear that the durability of the thin wall sections 46 and 56 is lowered.

However, in this embodiment, the thin wall section 46 is recessed with respect to the thick wall section 44 on the first face 43a, and is formed to be coplanarly joined to the thick wall section 44 on the second face 43b, and the thin wall section 56 is recessed with respect to the thick wall section 54 on the first face 53a, and is formed to be coplanarly joined to the thick wall section 54 on the second face 53b. Thus, the inner wall face 13 can be difficult, to come into contact with the thin wall section 46, and the inner wall face 14 can be difficult to come into contact with the thin wall section 56, so that the lowering of the durability of the thin wall sections 46 and 56 caused by the contact of them can be prevented. Further, the inner wall face 13 can be more difficult to come into contact with the thin wall section 46 by the rib 47, and the inner wall face 14 can be more difficult to come into contact with the thin wall section 56 by the rib 57, so that the lowering of the durability of the thin wall sections 46 and 56 caused by the contact of them can be further prevented.

Also, the inner wall face 13 of the first bracket 10 to which the power unit side is fixed can be difficult to come into contact with the thin wall section 46, and the inner wall face 14 of the first bracket 10 to which the power unit side is fixed can be difficult to come into contact with the thin wall section 56, so that the vibration of the power unit can be difficult to be transmitted through the first bracket 10 to the thin wall sections 46 and 56. Therefore, the durability of the thin wall sections 46 and 56 can be secured.

The thick wall section 44 is provided over the portion of the cushioning section 43 away from the symmetrical line segment S3 with respect to the thin wall section 46. The thick wall section 54 is provided over the portion of the cushioning section 53 away from the symmetrical line segment S4 with respect to the thin wall section 56. Thus, in the portion in which the force moment is relatively small, the shock of the inner wall face 13 and the end face 23 can be sufficiently cushioned by the thick wall section 44 that is relatively thick, and in the portion in which the force moment is relatively small, the shock of the inner wall face 14 and the end face 24 can be sufficiently cushioned by the thick wall section 54 that is relatively thick. Therefore, since the thin wall section 46 can be more difficult to be sandwiched between the inner wall face 13 and the end face 23, the shock caused by the large force moment can be difficult to be applied through the thin wall section 46 to the inner wall face 13 and the end face 23, and since the thin wall section 56 can be more difficult to be sandwiched between the inner wall face 14 and the end face 24, the shock caused by the large force moment can be difficult to be applied through the thin wall section 56 to the inner wall face 14 and the end face 24.

The present invention has been described based on the embodiment, but the present invention is not limited to the embodiment at all, and it can be easily inferred that various modifications can be made within the scope not departing from the purport of the present invention. For example, the shape of each part of the first bracket 10, the second bracket 20, the vibrationproofing device 30, and the stoppers 40 and 50 and the dimension and material of each part of the first bracket 10, the second bracket 20, the vibrationproofing device 30, and the stoppers 40 and 50 are examples, and of coarse, various shapes, dimensions, and materials are adopted.

For example, the inside member 31 can be formed to be in a shaft shape, such as a columnar shape. Also, the first bracket 10 may be fixed to the vehicle body side, and the second bracket 20 may be fixed to the power unit side. The shapes, arrangements, and the like of the plurality of protrusion sections 45 and 55 may be changed, and the protrusion sections 45 and 55 may be omitted.

The outside member 32 of the vibrationproofing device 30 may be omitted to couple the inner circumferential face of the tubular section 21 and the outer circumferential face of the inside member 31 by the vibrationproofing base body 33. Also, the end face 34 of the outside member 32 may be located on the same plane as the end face 23 of the tubular section 21, and the end face 35 of the outside member 32 may be located on the same plane as the end face 24 of the tubular section 21. In these cases, preferably, the cushioning section 43 is provided also in the portion in which the inner wall face 13 of the first bracket 10 and the end face 34 are opposite, thereby providing the thin wall section 46 in the opposite portion closest to the symmetrical line segment S3, and the cushioning section 53 is provided also in the portion in which the inner wall face 14 of the first bracket 10 and the end face 35 are opposite, thereby providing the thin wall section 56 in the opposite portion closest to the symmetrical line segment S4.

In the embodiment, there have been described the case where the mounting hole 42 of the mounting section 41 of the stopper 40 is fitted to the inside member 31 and the case where the mounting hole 52 of the mounting section 51 of the stopper 50 is fitted to the inside member 31, but the present invention is not. necessarily limited to these. As long as the cushioning section 43 of the stopper 40 is disposed between the inner wall face 13 and the end face 23, the method for mounting the stopper 40 is not limited, and as long as the cushioning section 53 of the stopper 50 is disposed between the inner wall face 14 and the end face 24, the method for mounting the stopper 50 is not limited. For example, the mounting section 41 may be omitted to couple the edge of the cushioning section 43 to the outer circumferential side of the tubular section 21 to form the stopper, thereby covering the stopper on the tubular section 21, and the mounting section 51 may be omitted to couple the edge of the cushioning section 53 to the outer circumferential side of the tubular section 21 to form the stopper, thereby covering the stopper on the tubular section 21.

In the embodiment, there have been described the case where the inner wall face 13 and the end face 23 are overlapped in the symmetrical line segment S3 of the fastening point 22b with respect to the axis C of the inside member 31, as viewed in the plate thickness direction, and at least a portion of the thin wall section 46 is provided in the overlapping portion (the symmetrical line segment S3) and the case where the inner wall face 14 and the end face 24 are overlapped in the symmetrical line segment S4 on the fastening point 22b with respect to the axis C of the inside member 31, as viewed in the plate thickness direction, and at least a portion of the thin wall section 56 is provided in the overlapping portion (the symmetrical line segment S4), but the present invention is not limited to these. The inner wall face 13 and the end face 23 may be overlapped, as viewed in the plate thickness direction, within the predetermined range that is the symmetrical position S1 of the fixing face 22a with respect to the inside member 31, thereby providing at least a portion of the thin wall section 46 in the overlapping portion. The inner wall face 14 and the end face 24 may be overlapped, as viewed in the plate thickness direction, within the predetermined range that is the symmetrical position S2 of the fixing face 22a with respect to the inside member 31, thereby providing at least a portion of the thin wall section 56 in the overlapping portion.

Also, the present invention is not limited to the case where the inner wall face 13 and the end face 23 are overlapped in the symmetrical line segment S3 and the symmetrical position Si and the case where the inner wall face 14 and the end face 24 are overlapped in the symmetrical line segment S4 and the symmetrical position S2. In these cases, at least a portion of the thin wall section 46 may be provided in the portion in which the inner wall face 13 and the end face 23 are overlapped and closest to the symmetrical line segment S3 and the symmetrical position S1, and at least a portion of the thin wall section 56 may be provided in the portion in which the inner wall face 14 and the end face 24 are overlapped and closest to the symmetrical line segment S4 and the symmetrical position S2. Thus, the shock in the portion in which the force moment from the inner wall face 13 toward the end face 23 is the largest can be difficult to be applied through the thin wall section 46 to the inner wall face 13 and the end face 23, and the shock in the portion in which the force moment from the inner wall face 14 toward the end face 24 is the largest can be difficult to be applied through the thin wall section 56 to the inner wall face 14 and the end face 24.

Also, the present invention is not limited to the case where the thin wall section 46 is provided in the portion to which the shock with the large force moment is applied and the case where the thin wall section 56 is provided in the portion to which the shock with the large force moment is applied. For example, according to the gravity center position of the power unit, the fixing position of the first bracket 10 to the power unit, and the like, the thin wall section 46 may be provided in the portion in which the large shock is likely to be applied from the inner wall face 13 to the end face 23, and the thin wall section 56 may be provided in the portion in which the large shock is likely to be applied from the inner wall face 14 to the end face 24.

In the one embodiment, there have been described the case where the thin wall section 46 is recessed with respect to the thick wall section 44 on the first face 43a, and the thick wall section 44 and the thin wall section 46 are coplanarly joined on the second face 43b and the case where the thin wall section 56 is recessed with respect to the thick wall section 54 on the first face 53a, and the thick wall section 54 and the thin wall section 56 are coplanarly joined on the second face 53b, but the present invention is not necessarily limited to these. The thick wall section 44 and the thin wall section 46 may be coplanarly joined on the first face 43a, and the thin wall section 46 may be formed to be recessed with respect to the thick wall section 44 on the second face 43b. The thick wall section 54 and the thin wall section 56 may be coplanarly joined on the first face 53a, and the thin wall section 56 may be formed to be recessed with respect to the thick wall section 54 on the second face 53b. In these cases, when the inside member 31 is displaced in the prying direction relative to the tubular section 21, the thin wall section 46 of the stopper 40 fixed to the inside member 31 is difficult to come into contact with the end face 23 of the tubular section 21, and when the inside member 31 is displaced in the prying direction relative to the tubular section 21, the thin wall section 56 of the stopper 50 fixed to the inside member 31 is difficult to come into contact with the end face 24 of the tubular section 21. Thus, the lowering of the durability of the thin wall section 46 caused by the contact with the end face 23 can be prevented, and the lowering of the durability of the thin wall section 56 caused by the contact with the end face 24 can be prevented. Also, on both of the first face 43a and the second face 43b, the thin wall section 46 may be recessed with respect to the thick wall section 44, and on both of the first face 53a and the second face 53b, the thin wall section 56 may be recessed with respect to the thick wall section 54.

In the one embodiment, the case where the fixing face 22a is present in one location in the circumferential direction of the tubular section 21 has been described, but the present invention is not necessarily limited to this. A plurality of fixing faces may be provided in a plurality of locations in the circumferential direction of the tubular section 21. A plurality of thin wall sections 46 may be respectively provided in the positions where the symmetrical positions S1 and the symmetrical line segments S3 of the respective fastening points 22b of the plurality of fixing faces with respect to the axis C are overlapped, and a plurality of thin wall sections 56 may be respectively provided in the positions where the symmetrical positions S2 and the symmetrical line segments S4 of the respective fastening points 22b of the plurality of fixing faces with respect to the axis C are overlapped. Also, when a plurality of fixing faces are provided in a plurality of locations within the half circumference of the tubular section 21, the plurality of fixing faces may be assumed as one fixing face, and the center of two end edges separated most in the circumferential direction may be the fastening point 22b.

In the one embodiment, there have been described the case where a portion of the thick wall section 44 including the rib 47 is continuously provided on the entire periphery of the thin wall section 46 and the case where a portion of the thick wall section 54 including the rib 57 is continuously provided on the entire periphery of the thin wall section 56, but the present invention is not necessarily limited to these. As long as the moldability and strength of the thin wall section 46 can be sufficiently secured, the rib 47 may be discontinuously provided around the thin wall section 46 or may be omitted. As long as the moldability and strength of the thin wall section 56 can be sufficiently secured, the rib 57 may be discontinuously provided around the thin wall section 56 or may be omitted.

1. A stopper that is mounted on a vibrationproofing unit including a first bracket fixed to one of a power unit side and a vehicle body side, a second bracket fixed to the other of the power unit side and the vehicle body side, an inside member being shaft shaped and in which the first bracket is fixed to the axial ends of the inside member, and a vibrationproofing base body including a rubber-like elastic body and coupling the outer circumferential face of the inside member and the inner circumferential face side of a tubular section of the second bracket, the stopper being plate shaped, including a rubber-like elastic body, and including a cushioning section disposed between the portions of the first bracket and the tubular section opposite in an axial direction of the tubular section,
wherein the cushioning section includes:
a thick wall section;
a plurality of protrusion sections protruding from at least one face in a plate thickness direction of the thick wall section; and
a thin wall section thinner than the thick wall section.

2. The stopper according to claim 1, wherein a portion of the thick wall section is provided between the edge of the cushioning section and the thin wall section.

3. The stopper according to claim 2, wherein a portion of the thick wall section is continuously provided on the entire periphery of the thin wall section.

4. A vibrationproofing unit comprising:
a first bracket fixed to one of a power unit side and a vehicle body side;
a second bracket having a tubular section opposite a portion of the first bracket in an axial direction and a fixing face fixed in contact with the other of the power unit side and the vehicle body side;
an inside member being shaft shaped, disposed on the inner circumferential side of the tubular section, and in which the first bracket is fixed to the axial ends of the inside member;
a vibrationproofing base body including a rubber-like elastic body and coupling the outer circumferential face of the inside member and the inner circumferential face side of the tubular section; and
a stopper being plate shaped and including a rubber-like elastic body,
wherein the stopper includes a cushioning section disposed between the portions of the first bracket and the tubular section opposite in the axial direction,
wherein the cushioning section includes:
a thick wall section; and
a thin wall section thinner than the thick wall section,
wherein at least a portion of the thin wall section is provided in the portion in which the first bracket and the tubular section are overlapped, as viewed from the axial direction and closest to a symmetrical position of the fixing face with respect to the inside member.

5. The vibrationproofing unit according to claim 4, wherein the first bracket and the tubular section are overlapped, as viewed from the axial direction, in the symmetrical position, and at least a portion of the thin wall section is provided in the overlapping portion.

6. The vibrationproofing unit according to claim 4, wherein the thick wall section is provided over the portion of the cushioning section away from the symmetrical position with respect to the thin wall section.

7. The vibrationproofing unit according to claim 4,
wherein the first bracket is fixed to the power unit side,
wherein the fixing face is fixed to the vehicle body side,
wherein the cushioning section includes a first face facing the first bracket and a second face being the back side of the first face and facing the tubular section,
wherein the thin wall section is recessed with respect to the thick wall section on the first face, and is formed to be coplanarly joined to the thick wall section on the second face.

8. The vibrationproofing unit according to claim 4, wherein the cushioning section includes a plurality of protrusion sections protruding from at least one face in a plate thickness direction of the thick wall section.
